(19) United States
(12) Patent Application Publication
(10) Pub. No.: US 2016/0045025 A1
(43) Pub. Date: Feb. 18, 2016

(54) CABINET HANGING AND ALIGNING DEVICE AND METHOD

(71) Applicant: Timothy James Trunkle, Charleston, SC (US)

(72) Inventor: Timothy James Trunkle, Charleston, SC (US)

(21) Appl. No.: 14/458,914

(22) Filed: Aug. 13, 2014

(51) Int. Cl. A47B 95/00; F16M 13/02

(52) U.S. Cl. CPC A47B 95/008; F16M 13/02

(57) ABSTRACT

A wall rail system for hanging and aligning cabinets has a wall rail member and a cabinet bracket member. The wall rail member is mounted to a wall. The cabinet bracket member is mounted to an upper back portion of a cabinet. An upper portion of the cabinet bracket member is constructed and arranged for insertion into the lower portion of the wall rail member. The upper portion of the cabinet bracket member is retained within the lower portion of the wall rail member, which aligns the cabinet for mounting to the wall.

### FIELD OF THE INVENTION

This invention relates to cabinets, and is more particularly directed to a device and method for hanging and aligning wall cabinets.

### BACKGROUND OF THE INVENTION

Prefabricated cabinets are the most common type of cabinets installed in homes today. Whether they are being installed by volume builders in production style homes, or by an individual homeowner performing a remodeling job, prefabricated cabinetry offers a variety of selections and affordability that has made them a popular choice.

Frequently, spacing of wall studs into which cabinets are mounted does not coincide with the manufactured hanging strips for the varying sizes of cabinets. Consequently, the recommended number of wall cabinet hanging fasteners for mounting to wall studs may not be utilized. Localized loads on the cabinet hanging framework may be in excess of recommended loading, thereby resulting in damage to the structural integrity of the cabinet, especially when the cabinet is in use as storage by the user.

Further, undulations or variations in the wall surface where the cabinets are mounted may cause the prefabricated cabinet hanging strip to become separated from the cabinet when the strip is secured to the wall. In the event that an installation fastener is improperly shimmed, the fastener may separate the hanging strip from the cabinet, especially when a fastener is placed near the center of the cabinet hanging strip.

In order to install wall cabinets in a more secure manner, the location of each wall stud of a wall on which cabinets are hung must be conformed to the hanging points of the cabinet. This process is both time consuming and tedious and does not allow for error. Cabinets are usually installed one at a time by securing the cabinet to the wall, and additional cabinets are installed next to the previously positioned cabinet unit(s). Each successive cabinet unit is attached to the wall adjacent to the previous cabinet unit, requiring alignment vertically, horizontally and across the face of the cabinet units to be maintained. Even minor variations or change in placement of the cabinets usually requires considerable additional measuring and modification.

There is a need for a device and method for hanging and aligning cabinets that installs quickly and easily, increases the strength and integrity of the cabinet unit, and can be employed on any prefabricated cabinet unit and most custom cabinets that allows for placement and alignment of wall of cabinets prior to securing the cabinets to a wall.

### SUMMARY OF THE INVENTION

A wall rail system for hanging and aligning cabinets has a wall rail member and a cabinet bracket member. The wall rail member is mounted to a wall. The cabinet bracket member is mounted to an upper back portion of a cabinet. A lower portion of the wall rail member extends upwardly and outwardly from the middle portion at an angle. An upper portion of the cabinet bracket member extends first outwardly from the cabinet bracket member and then downwardly and toward the cabinet bracket member to form a generally inverted V shape configuration. The upper portion of the cabinet bracket member is constructed and arranged for insertion into the lower portion of the wall rail member. The upper portion of the cabinet bracket member is retained within the lower portion of the wall rail member, which aligns the cabinet for mounting to the wall.

### BRIEF DRAWING DESCRIPTION

FIG. 1 depicts the wall hanging rail in isometric perspective.

FIG. 2 depicts the cabinet bracket in isometric perspective.

FIG. 3 depicts a side, sectioned view of the assembled wall cabinet hanging device, showing the cabinet bracket engaged in the wall rail, with a mounted cabinet top and back demonstrated as a phantom.

FIG. 4 depicts a perspective view demonstrating the assembled wall cabinet hanging device of FIG. 3.

### DESCRIPTION OF PREFERRED EMBODIMENTS

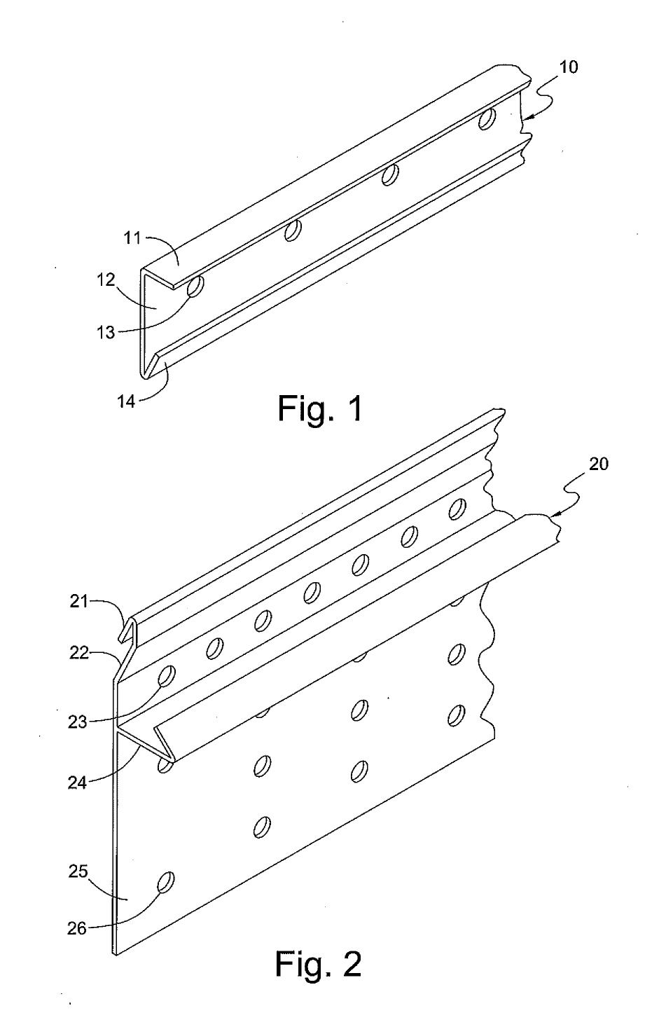

FIG. 1 shows an embodiment of a wall mounting rail 10. The wall mounting rail is preferred to be an elongated and generally rigid member. The wall mounting rail as shown has an upper leg 11 that may be formed generally perpendicularly to the middle portion 12 of the wall mounting rail, and extending from the top of the middle portion. The middle portion 12 is preferred to have a plurality of holes 13 that are constructed to receive mounting fasteners. The holes 13 are spaced to permit mounting in a variety of wall stud spacings. In one embodiment, the holes 13 are spaced 0.75 inches apart along the centerline of the rail, which provides many mounting holes for adapting mounting to various wall stud configurations.

A lower portion 14 of the wall mounting rail 10 is formed to provide a channel. The channel may be formed by the lower portion extending outwardly and upwardly from a bottom of the middle portion 12, and toward an upper portion of the wall mounting rail. A V shaped or U shaped channel is formed. The lower portion 14 may join the middle portion at an angle of 15 to 75 degrees, and more preferably, at 30 to 60 degrees.

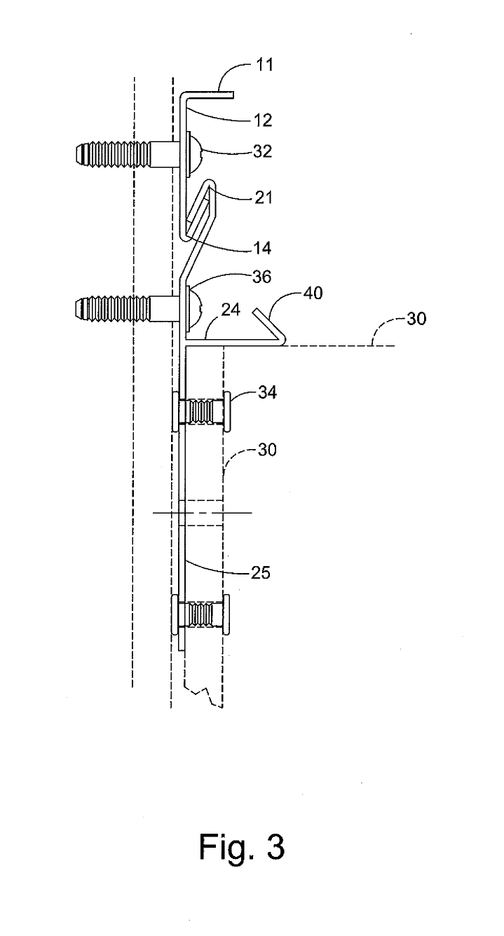

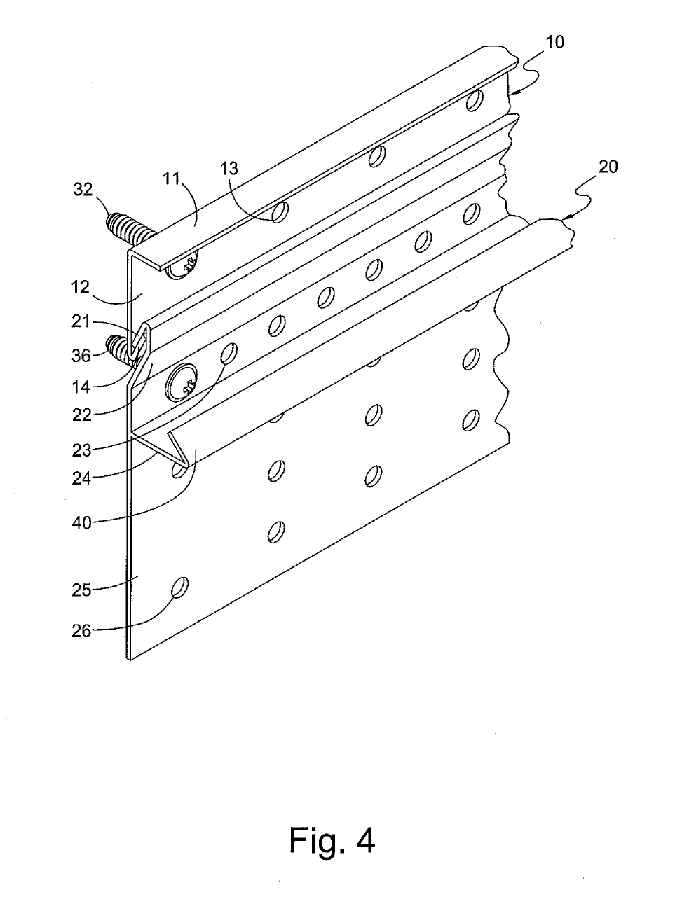

FIG. 2 shows a cabinet mounting bracket 20 according to an embodiment of the invention. The cabinet mounting bracket is preferred to be an elongated and generally rigid member. The cabinet mounting bracket as shown has an inverted V or U shaped channel 21 in an upper portion. The upper portion of the cabinet mounting bracket extends away from the lower portion 25 of the bracket as an offset 22, and then downwardly at an opposite end toward the lower portion to form the inverted channel. The offset allows the lower portion 25 of bracket 20 to align with middle portion 12 of the wall rail 10 when the inverted channel portion 21 is inserted into wall rail 10 lower portion 14. The angle of the inverted channel portion is preferred to be formed so that the surface of the inverted channel is against substantially the entire interior surface of the lower portion 14 as shown in FIG. 3.

The middle portion 24 in this embodiment is a leg extends which generally perpendicularly to the lower portion 25. The leg may an upward extension 40 at or near the end thereof. The extension may form a V shaped edge, and may have a length of about 0.625 inches.

The lower portion 25 may have a plurality of mounting holes 26 that extend along the length of the bracket 20. The bottom portion may have a series of holes, such as 3 evenly spaced and vertically aligned 0.25 inch diameter holes starting at a distance of 0.5 inches below the perpendicular leg 24 extending to within 0.5 inches of the bottom of said bracket.

The wall mounting rail may be formed of metal such as steel with punched holes formed for receiving the required fasteners. The holes may be 0.025 dia. holes set on 0.75 inch centers. The rail may be formed in lengths as required, and may be formed in lengths of 8 feet, and cut to the desired length at the time of use. Multiple sections may be used as needed for length requirements.

In use, the wall mounting rail is leveled on a wall at a pre-determined height and mounted to studs, such as by screws 32. For example, #10-2% inch pan head screws may be attached to each wall stud and shimmed as needed with metal or plastic square slotted washers. The perpendicular leg 11 adds rigidity that helps provides a straight mounting plane, and also acts as a guide or upper limit when positioning the cabinet mounting bracket 20. The wall mounting rail is attached to the wall studs, which is facilitated by the multiple mounting holes that are frequently spaced along the rail. The rail eliminates the need for mounting the cabinets directly in the studs during alignment, and eliminates the need for the associated precision measuring during the cabinet mounting process.

The cabinet mounting bracket may also be formed of metal such as steel, and may be formed in lengths as required. The cabinet mounting bracket may be formed in 8 foot lengths that can be cut to length such as with a hacksaw.

The cabinet mounting bracket is mounted on the upper back of any pre-fabricated cabinet 30. Vertical alignment is provided by leg 24 that is formed at a right angle to the cabinet mounting bracket. The cabinet mounting bracket is preferred to be attached at several points across the length of the cabinet bracket. The selected attachment holes 26 in the bracket serve as drill alignment holes. Holes are drilled through the cabinet and the cabinet mounting bracket is attached to the cabinet such as with screws 34. In one embodiment, #8-32×¾ inch low profile machine screws are inserted through the drilled hole and are captured by #8-32×¾ inch Tee nuts installed on the inside of the cabinet. This structure provides holding capacity that is superior to the cabinet structure alone, and spreads the load across the entire internal hanging rail of the cabinet, thereby eliminating a tendency of the cabinet to separate at the attachment point. This separation often occurs when the cabinet is secured at too few alignment points.

After a cabinet mounting bracket is attached, the cabinet is then hung on the wall rail in its approximate pre-determined location. This step is repeated until all of the wall cabinets are in place on the wall rail. After all are in place they can be adjusted by moving the cabinet bracket horizontally along the wall mounting rail as needed to provide for desired margins and alignment.

Once final positioning of the cabinets is determined, the faces of the cabinets are secured for front plane alignment. After the cabinet faces are aligned and secured, the cabinets are permanently secured. For example, screws 36, such as #10×2 ½ inch pan head screws, may be installed through the cabinet mounting bracket holes 23 that may be positioned just below the inverted V portion of the cabinet mounting bracket and in line with the wall mounting rail, with a mounting screw visible just above the bracket/rail attachment point. This prevents movement of the upper portion of the wall cabinet. Holes 23 may be located at a point on the cabinet mounting bracket a distance of about 0.375 inches from the bottom of the offset.

Fasteners are installed through each cabinet's lower internal hanging strip as per the cabinet manufacturer's recommendations. The fasteners are installed at wall stud positions previously located when installing the wall mounting rail.

This invention provides a wall cabinet hanging and alignment system that eliminates many problems associated with cabinet alignment and hanging. This novel hanging system 1) speeds installation time by eliminating the majority of the typical calculating and measurement transfers associated with cabinet installation; 2) increases the structural integrity of the cabinets; 3)allows for alignment adjustments prior to final attachment; and 4) is universally adaptable for use on any standard manufactured wall cabinet. The wall rail provides a permanent horizontal alignment along a wall, while the unique cabinet bracket, by design, automatically ensures vertical alignment and strengthens the integrity of any cabinet mounted on the rail.

1. A wall rail system for hanging and aligning cabinets on a vertical wall surface comprising:
(a) an elongated and generally horizontal wall rail member, the elongated and generally horizontal wall rail member comprising an upper portion, a middle portion and a lower portion, the upper portion comprising a leg formed generally perpendicularly to the middle portion, the middle portion having a generally flat surface and comprising a plurality of holes formed therein, and the lower portion extending upwardly toward the upper portion and outwardly from the middle portion at an angle of 30 degrees to 60 degrees; and
(b) an elongated and generally horizontal cabinet bracket member, the elongated and generally horizontal cabinet bracket member comprising an upper portion and a lower portion, the upper portion of the cabinet bracket member extending first outwardly from the lower portion of the cabinet bracket member and then downwardly and toward the lower portion of the cabinet bracket member to form a generally inverted channel, the generally inverted channel of the upper portion of the cabinet bracket member being constructed and arranged at an angle that corresponds to the 30 degrees to 60 degrees angle of the lower portion of the wall rail member for insertion of the lower portion of the wall rail member into the generally inverted channel of the upper portion of the cabinet bracket member, wherein the upper portion of the cabinet bracket member is retained by the lower portion of the wall rail member, the lower portion of the cabinet bracket member comprising a hole formed therein that is constructed and arranged to receive a fastener.

2. A wall rail system for hanging and aligning cabinets on a vertical wall surface as described in claim 1, further comprising a leg extending generally perpendicularly from a middle portion of the cabinet bracket member.

3. A wall rail system for hanging and aligning cabinets on a vertical wall surface as described in claim 1, further comprising a generally perpendicular extension extending from the upper portion of the wall rail member.

4. A wall rail system for hanging and aligning cabinets on a vertical wall surface as described in claim 1, wherein the plurality of holes formed in the middle portion of the wall rail member are spaced about 0.75 inches apart.

5. A wall rail system for hanging and aligning cabinets on a vertical wall surface as described in claim 1, wherein an upper portion of the cabinet bracket member is offset sufficiently to enable the lower portion of the cabinet bracket member to align with the middle portion of the wall rail member in a planar fashion when the upper portion of the cabinet bracket engages the lower portion of the wall rail member.

6. A wall rail system for hanging and aligning cabinets on a vertical wall surface as described in claim 1, further comprising a plurality of holes in an upper portion of cabinet bracket member that are each spaced apart at a same distance as the plurality of holes in the middle portion of the wall rail member.

7. A wall rail system for hanging and aligning cabinets on a vertical wall surface as described in claim 1, wherein the cabinet bracket member comprises a leg that is formed generally perpendicularly to the lower portion of the cabinet bracket member and the leg comprises an upwardly extending member near an end thereof.

8. A wall rail system for hanging and aligning cabinets on a vertical wall surface as described in claim 1, wherein the bottom portion of the cabinet bracket member comprises a series of 3 evenly spaced apart and vertically aligned holes.

9. A wall rail system for hanging and aligning cabinets on a vertical wall surface as described in claim 1, wherein the plurality of holes in the wall rail member and a plurality of holes in the cabinet bracket member extend substantially the entire length of the cabinet bracket member.

10. A wall rail system for hanging and aligning cabinets on a vertical wall surface as described in claim 1, wherein the wall rail bracket member is a rigid member and the cabinet bracket member is a rigid member.

11. A wall rail system for hanging and aligning cabinets on a vertical wall surface as described in claim 1, wherein an upper portion of the cabinet bracket member is offset from the lower portion of the cabinet bracket member and the upper portion of the cabinet bracket member is in contact with the middle portion of the wall rail member when the lower portion of the wall rail member is positioned in the generally inverted channel of the upper portion of the cabinet bracket member.

12. A wall rail system for hanging and aligning cabinets on a vertical wall surface as described in claim 1, further comprising a cabinet mounted to the lower portion of the cabinet bracket member and on the same side of the cabinet bracket member as an offset in the upper portion of the cabinet bracket member.

13. A wall rail system for hanging and aligning cabinets on a vertical wall surface as described in claim 1, further comprising a cabinet mounted to the lower portion of the cabinet bracket member, wherein the cabinet abuts a leg that is formed generally perpendicularly to the lower portion of the cabinet bracket member and extends outwardly from the cabinet bracket member for alignment of the cabinet with the cabinet bracket member.

14. A wall rail system for hanging and aligning cabinets on a vertical wall surface as described in claim 1, wherein a plurality of fasteners extends through the plurality of holes formed in a middle portion of the wall rail member, with heads of the fasteners positioned below and on the same side of the middle portion of the wall rail member as the upper portion of the wall rail member.
